(19) United States
(12) Patent Application Publication
(10) Pub. No.: US 2010/0121723 A1
(43) Pub. Date: May 13, 2010

(54) METHOD FOR GENERATION OF EXCESS FUNDS FROM CREDIT INSTRUMENTS EARMARKED FOR PERSONAL USE AND DISTRIBUTION

(76) Inventors: Peggy A. Miller, Yonkers, NY (US); Patrick J. Murphy, Temecula, CA (US)

Correspondence Address: OSTROLENK FABER GERB & SOFFEN, 1180 AVENUE OF THE AMERICAS, NEW YORK, NY, 100368403, US

(21) Appl. No.: 12/690,522

(22) Filed: Jan. 20, 2010

Related U.S. Application Data
(63) Continuation of application No. 12/103,868, filed on Apr. 16, 2008, now abandoned.
(60) Provisional application No. 60/912,324, filed on Apr. 17, 2007.
(60) Provisional application No. 60/912,033, filed on Apr. 16, 2007.

(51) Int. Cl. G06Q 40/00; G06Q 30/00

(52) U.S. Cl. 705/16

(57) ABSTRACT

A method of generating excess funds through use of a credit instrument, the excess funds being earmarked for at least one entity. The method including the steps of: at least one credit issuer affiliating a credit instrument with the at least one entity; at least one consumer obtaining the affiliated credit instrument and using it to make one or more purchase transactions at one or more points of sale, each transaction having an amount of purchase; and the at least one credit issuer processing each of the one or more purchase transactions using the following steps: performing credit instrument transaction processing procedures using a credit instrument processing network; at a period predefined for generating excess funds determining if an instrument used to pay for the purchase transaction being processed is the affiliated credit instrument; and if the instrument is the affiliated credit instrument, generating funds in excess of a sum total amount of all purchase transactions made using the instrument at all points of sale.

### CROSS-REFERENCE TO RELATED APPLICATIONS

This is a continuation of U.S. patent application Ser. No. 12/103,868, filed Apr. 16, 2008 entitled A METHOD FOR GENERATION OF EXCESS FUNDS FROM CREDIT INSTRUMENTS EARMARKED FOR PERSONAL USE AND DISTRIBUTION, which application is based on and claims priority to U.S. Provisional Patent Application Ser. Nos. 60/912,033, filed on Apr. 16, 2007, entitled A METHOD FOR COLLECTION OF CHANGE FROM CREDIT NETWORK PURCHASES FOR PERSONAL USE AND CHARITABLE DONATION and 60/912,324, filed on Apr. 17, 2007, entitled A METHOD FOR COLLECTION OF CHANGE FROM CREDIT NETWORK PURCHASES FOR PERSONAL USE AND CHARITABLE DONATION, the entire contents of which are hereby incorporated by reference.

### BACKGROUND OF THE INVENTION

The present invention relates to attracting, acquiring and retaining holders of credit instruments, and encouraging frequent use of issued credit instruments, and more particularly to generating excess funds for use as donations, contributions and payments to third parties or for credit accumulation by the holders of the credit instruments.

Banks, related financial institutions, e.g., credit unions, insurance providers, brokerage firms, etc., merchants, e.g., department stores, gas companies, etc., and any other entity legally entitled to offer credit line or charge account privileges (collectively, with their vendors, “credit issuers”) to consumers, businesses, government agencies and other users (collectively, “consumers”) are having an increasingly difficult time differentiating themselves to consumers in order to generate new credit card customers and to encourage selection and use of the credit card issued by the particular credit issuer in each purchase transaction by each credit card holder. The term “credit card” and the term “credit instrument” are used to mean any credit line account or charge account issued by a credit issuer which may be utilized by an authorized credit instrument account holder (“holder”) to engage in transactions with merchants including transactions commonly referred to as “point of sale” (or “POS”) transactions utilizing any credit network POS payment processing system now known or later developed (“credit processing network”), regardless of the physical or non-physical token, tool or method provided to and utilized by the holder. Such physical tokens, tools and methods may include but are not limited to a traditional plastic credit card or charge card with a magnetic strip, a digital phone with an embedded RFID chip coded with the necessary credit instrument processing information, a biometric reader at POS keyed to relevant data, a SpeedPass® as well as any other physical or non-physical methods and devices now known or later developed to utilize a credit instrument at POS.

Many credit issuers utilize the same major, well-known credit processing networks for POS purchases between a holder of the credit instrument and a merchant under applicable laws. Examples of these credit processing networks include systems provided by VISA®, MasterCard®, American Express®, Discover®, etc. Additionally, merchant-controlled credit processing network systems, e.g., ExxonMobil SpeedPass™ and merchant-specific systems, such as Macy's®, Kohl's®, etc., and vendor-controlled systems such as those provided by FDR, PayPal™, AirCharge, etc., are utilized by the relevant merchant at POS and by the merchant's bank and by the credit issuers. Due to the volume, speed, and complexity of transactions performed by the credit processing networks, any requirement for different or exception-based POS transaction processing utilizing any of the POS credit processing networks is expensive and often impractical.

The credit issuers sometimes seek relationships with charitable, educational, political or other organizations having name recognition (“affinity organizations”), to market their credit instrument products. Examples of the affinity organizations include the Red Cross, the American Automobile Association®, Columbia University, the Democratic National Committee and Bloomingdale's. Some of the affinity entities involved with credit issuers are institutions of higher education. For example, alumni/ae of a specific university may be offered a credit instrument, which results in contributions by the credit issuer to the university based in part on the total dollar amount of all transactions of the alumni/ae holders of such credit instrument. The alumni/ae may be interested in applying for, activating and using the university-linked credit instrument for sentimental or charitable reasons, in being associated with and helping the university by generating payments from the credit issuer to the university.

By associating the credit instrument with the affinity organizations, the credit issuers create credit instruments each having an affinity with one or more affinity organizations and/or with the holder's self-interest (“affinity credit instruments”). This affinity is intended to encourage frequent credit card use. For example, Maryland Bank, National Association (MBNA), which is a wholly-owned subsidiary of Bank of America, has agreements with numerous affinity entities/organizations to provide a specific credit card associated with the charity or university to their members and alumni/ae. Often, the credit issuer will make donations to the non-profit entities and contributions to other affinity organizations to promote use of the affinity credit instruments, e.g., credit cards.

Alternatively or additionally, the credit issuers may seek to market their credit cards by appealing to the self-interest of the prospective holder of the affinity credit instruments, such as by awarding airline travel miles such as Delta SkyMiles®, sports team paraphernalia such as Yankees® fan items, or discounts on fees such as those charges at Disney® amusement parks, based on the total monthly dollar amount of the credit instrument holder's transactions, or by awarding points that can be used by the credit instrument's holder to receive products, services, or future discounts, such as those provided by the American Express® Membership Miles® program. The awards are usually earned when the credit instrument's holder accepts, activates and utilizes the credit instrument for making at least one POS transaction, and the awards are intended by the credit issuer to satisfy a self-interest of the credit instrument's holder, for example, earning free or reduced-fee flights on Delta Airlines® or free or reduced-fee New York Yankees' promoted merchandise or game tickets, or receiving various free or reduced-fee products and services arranged by American Express. Therefore, each credit instrument holder with a self-interest in themselves, as well as each affinity organization, can be considered to be an “affinity entity”.

The credit issuers find great benefits in affiliating with the affinity entities. These benefits include increased response, activation and retention rates for account holders of credit instruments affiliated with affinity organizations or with themselves, and the name recognition and the ability to associate with good will generated by the work of the affinity organization.

The payments made by the credit issuers to the affinity organizations under the existing programs are relatively small. The credit issuers usually pay the charity affinity organization a fee based on total transactions performed by the credit instrument holder, and/or the number of new credit instrument holders retained for a predetermined minimum period, and/or other factors usually favorable to the credit issuers' business.

However, two practical problems are faced by the credit issuers associating credit instruments with affinity organizations and by the affinity credit instrument holders: (a) existing programs do not generate funds for charity affinity organizations in excess of the small fees paid by the credit issuers, and (b) the affinity credit instrument holders are not told how much money has been paid to the affiliated charity affinity organizations as a result of the holder's use of his/her affinity credit instrument.

Collection of additional direct donations, i.e., funds to be paid to the charitable affinity organizations and provision of non-profit tax receipts to the affinity credit instrument holders for applicable donations, has been costly, requiring creation and implementation of a specialized processing network separate and apart from the processing networks commonly utilized by the POS merchants, merchant banks and credit issuers for processing the credit card transactions. Similarly, reporting the calculation of the donation amount contributed to the charity affinity organization specifically due to holder's affinity credit instrument use would require expensive exception processing before each monthly invoice is issued to the affinity credit instrument holder, necessitating additional related costs for processing and customer support expenditures for resulting questions and issue resolution. Similar problems arise in allowing the affinity credit instrument holders to contribute additional funds, or utilize additional funds to make payments, to other affinity entities.

What is needed is a way to promote credit instrument acceptance and usage based on an existing relationship or interest between the holder, or prospective holder, of the credit instrument and one or more affiliated entities that includes donations to charitable organizations, contributions and payments to other organizations as well as the credit instrument holder's self-interest in future discretionary spending or savings. The good will of the affinity credit instrument holder toward the affinity entity will enhance acceptance, activation and use of the credit instrument in order to generate additional funds for the affinity organization or for future use by the affinity credit instrument holder by promoting frequent use of the affinity credit instrument issued by the credit issuers.

It is further desirable to generate additional funds while avoiding the need for any new card or device at the POS to capture, record, collect and transmit additional affinity credit instrument holder contributions, i.e., the excess funds, to the affinity entity in the affinity credit instrument holder's name or as a credit to the affinity credit instrument holder, by using extracted data processing and standard fee, “On Us” or other merchant transactions supported by the credit issuers and the processing networks (as applicable) to stimulate the frequent usage of the affinity credit instrument.

A number of programs to provide easy, affordable methods to generate the excess funds for donation, contribution, payment or use as a credit against future purchases by the credit card holders have been suggested. U.S. Pat. No. 5,466,919 discloses a method of charity donation that uses credit cards. The method enables a credit cardholder to make a donation to a cardholder-selected charity at the point of sale moment when the cardholder makes a purchase using the credit card. The donated amount is paid by a sponsoring bank, the credit card company, or the cardholder. However, this method requires identification of a “BAX system” credit cards, i.e., those credit cards affiliated with a charity donation program, by the credit card network transaction processor. The method further requires that “BAX card” transaction data be directed to a special processor dedicated to transactions involving charity donations (see col. 3, lines 18-21). Identifying and separately processing the “BAX card” transactions increases the time and cost of processing such credit card transactions, a major defect which most likely impeded the commercialization of this method.

U.S. Pat. No. 5,555,497 describes a new remotely located machine with a modem that is able to take a donation via cash, credit or debit card and transmit the donation to a selected charity. This is a cumbersome process for the cardholder and for the merchant, who must acquire and maintain separate from their POS transaction processing device a new device to record and process the cardholder donations. Additionally, because this patent supports all donation means, it fails to sufficiently motivate credit card use by cardholders.

U.S. Pat. Nos. 6,088,682 and 6,112,191 describe attempts to automate more of the donation process. However, each teaches that separate from the network processing device, e.g., for VISA®, MasterCard®, American Express®, etc., the excess funds are generated at POS by the merchant/collectors who process the subscriber/card holders' transactions through a separate remote input device to calculate the excess funds difference between the purchase price of the goods or services and the amount of payment rendered by the card holder (see col. 2, lines 55-60 of Pat. No. 6,112,191 and col. 5, lines 7-10 of the Pat. No. 6,088,682). Once calculated at the POS, such amounts must be accounted for and carried through the entire processing network, including the use of separate identification cards or tokens and separate remote processing terminals, as applicable, thereby increasing processing costs. Additionally, if the credit card holder does not have the separately issued identification card at the POS, any proposed donation by the holder is impossible to calculate or collect.

Similarly, U.S. Pat. No 6,164,533 describes the merchant calculating, determining and collecting the rounded-up, excess change on credit card and debit card purchases by identified card holders through a special or modified card reader at the POS (see col. 4, lines 39-45 and col. 5, lines 3-16), and eventually depositing the excess change funds in a savings or Individual Retirement Account separately opened and maintained by the cardholder.

U.S. Pat. Nos. 6,876,971 and 6,467,684 describe other attempts to create a cost effective method to acquire credit card customers by enabling them to easily create excess credit card funds on a monthly basis for automatic donation to charity or for automatic use as a credit against future purchases also focus on POS events using newly issued customer identification cards separate and apart from the original credit instrument.

U.S. Pat. No. 7,080,775, in an attempt to avoid the POS costs and processing issues discussed above, focuses on back-end calculation and processing of rounded-up, excess funds by the merchant entity, e.g., the electric company, etc., receiving payment from a consumer and does not envision collection of the new, additional funds through a transaction placed on the monthly credit card holder statement, for example as a fee or “On Us” transaction.

U.S. Patent Application Publication No. 20030200163 describes encouraging consumers to save money by increasing their credit card transaction amounts in one of a number of ways and automatically investing such amounts in pre-determined investment accounts when minimum accumulated amounts are reached to avoid the cost of triggering a separate charge and transfer (see paragraph 0031). However, this application requires that the transaction be treated differently at POS from the regular POS transactions by the credit issuer once the customer is identified as a contributing customer, thereby increasing processing costs as explained above.

Similarly, U.S. Patent Application Publication No 20030225649 describes automatically funding pre-determined investment accounts with excess amounts calculated from credit card use (including round-up calculations, among other algorithms), and makes no mention of facilitating donation of such funds to charity or converting such funds to points for use as a credit against future cardholder purchases.

Other patents and patent applications, including U.S. Patents 6,164,533, 6,941,279, and U.S. Patent Application Publication No 20070033134 assigned to the Bank of America teach methods of calculating (including through periodically rounding up debited amounts) and collecting additional funds from credit or debit card purchases for automatic transfer and investment in savings and other pre-linked banking and investment accounts. However, none of these references utilize or suggest methods of utilizing commonly used or standard credit instrument processing to encourage acceptance and frequent usage of the credit instruments.

### SUMMARY OF THE INVENTION

It is an object of the present invention to enable the holders of the affinity credit instruments to generate excess funds through the use of their affinity credit instruments issued by the credit issuers in affiliation with at least one affinity entity and to donate or contribute the excess funds to such affinity entity, where the affinity entity may be the holder of the affinity credit instrument or an affinity organization.

It is another object of the present invention to enable the holders of the affinity credit instruments to generate excess funds through the use of the affinity credit instruments and to apply the excess funds as a credit against future purchases by the affinity credit instrument's holder, where the affinity entity is the holder of the affinity credit instrument.

Presented is a method of generating excess funds through use of a credit instrument, the excess funds being earmarked for at least one entity. The method includes the steps of: at least one credit issuer affiliating a credit instrument with the at least one entity; at least one consumer obtaining and activating the affiliated credit instrument and using it to make one or more purchase transactions at one or more points of sale, each transaction having an amount of purchase; and the at least one credit issuer processing each of the one or more purchase transactions. The processing step is carried out using the following steps: performing credit instrument transaction processing procedures using a credit instrument processing network; at a period predefined for generating excess funds, determining if an instrument used to pay for the purchase transaction being processed is the affiliated credit instrument; and if the instrument is the affiliated credit instrument, generating funds in excess of a sum total amount of all purchase transactions made using the instrument at all points of sale.

Other features and advantages of the present invention will become apparent from the following description of the invention which refers to the accompanying drawings

### BRIEF DESCRIPTION OF THE DRAWINGS

FIG. 1 is a diagram showing acquisition and activation of new affinity credit instrument holders by credit issuers as well as activating the features of the new affinity credit instruments for existing credit instrument holders in accordance with the present invention;

FIG. 2 is a diagram showing processing of the affinity POS credit instrument transactions utilizing a commonly used credit/charge network, and generating the excess funds in accordance with the present invention;

FIGS. 3a and 3b are a flowchart diagram illustrating performance of preferred embodiments of the present invention;

FIGS. 4, 5 and 6 are illustrations of physical devices which may be issued by the credit issuers and utilized by the affinity credit instrument holders to provide donations, contributions or payments in accordance with one embodiment of the present invention;

FIGS. 7, 8 and 9 are illustrations of physical devices which may be issued by the credit issuers and utilized by the affinity credit instrument holders for building credit in accordance with one embodiment of the present invention; and

FIGS. 10 and 11 are illustrations of physical devices which may be used by the affinity credit instrument holders as alternatives to the devices of FIGS. 4-9 for providing donations, contributions or payments and building credit in accordance with the embodiments of the present invention.

### DETAILED DESCRIPTION OF PREFERRED EMBODIMENTS OF THE INVENTION

For purposes of the present invention, any organization to which tax-deductible donations or non-tax deductible contributions or payments may be made under applicable law, such as charity affinity organizations and any other organization affiliated with a prospective credit instrument holder, i.e., non-charity affinity organizations, together with the credit instrument holder motivated by self-interest are each referred to as an “affinity entity”.

The present invention provides an affinity credit instrument issued by the credit issuers that enables its holders to automatically generate excess funds through the use of the affinity credit instrument, such as an affinity credit card, in making standard credit card POS purchases, and enables provision of donations, contributions and payments by the holder, in the amount of the excess funds, to the specific charity and non-charity affinity entity(ies) with which the affinity credit instrument is associated.

Further, the credit issuers are enabled to attract and acquire new and retain existing credit instrument holders by issuing affinity credit instruments to customers based on the customers' interest or affinity in associating with one or more specific affinity entities and in making donations, contributions or payments to such affinity entities. The affinity credit instrument holder's donations or contributions may be made using excess funds, which are generated monthly through any manner of calculations, including, in a preferred embodiment, by rounding up an amount charged for each POS affinity credit instrument transaction up to a pre-determined aggregate maximum amount. Alternatively, the excess funds may be generated by any number of ways, including adding a predetermined fixed or variable amount to the POS transaction amount or to the total amount owed by the credit instrument holder at any given time, or by changing the round-up calculation. Similarly, the excess funds may be calculated and applied daily, weekly, and/or monthly or according to other schedules or methods in accordance with the affinity credit instrument holders' preferences.

After the excess funds calculation is performed, the sum total of the resulting excess funds is placed as a fee or as a merchant charge, i.e., as a charge transaction, preferably as an “On Us” merchant transaction on each affinity credit instrument holder's statement issued by the credit issuers.

The collected excess funds can be donated, contributed or made as a payment to at least one specific affinity entity with the holder's affinity credit instrument is associated or to satisfy at least one of the affinity credit instrument holder's self-interest, be converted to points for use as credit against future purchases by the affinity credit instrument holder. The conversion of the excess funds to points and application as a credit may be achieved with or without promotional or matching funds or points from the credit issuers or non-charity affinity entities. In each case, i.e., donation, contribution, payment or credit of the excess funds, possible matching and promotional funds or points may be applied by the credit issuers, third party processors, affiliated entities or other entities, as applicable.

The present invention avoids extra costs associated with POS calculation, collection and processing of the excess funds by the merchants and the costs of adding the excess funds to the amounts cleared and charged at POS through credit network processor systems, e.g., VISA®, MasterCard®, etc., through application of a fee or separate charge, preferably as an “On Us” merchant transaction, to the credit instrument to receive the excess funds from the affinity credit instrument holder without involving the POS merchants. Further, the features of the present invention can be added to features of any existing credit instrument relationship, such as those currently offering airline miles or other rewards discussed above.

The present invention may be practiced for any financial transaction in which a licensed financial services entity credit issuer extends credit or charging account privileges in affiliation with one or more affinity entities to a prospective affinity credit instrument holder, enabling POS purchases utilizing a credit network including a merchant-specific payment processing network. Such transactions are commonly referred to as “credit card” transactions and generally are not referred as a “debit card” or “check card” transaction.

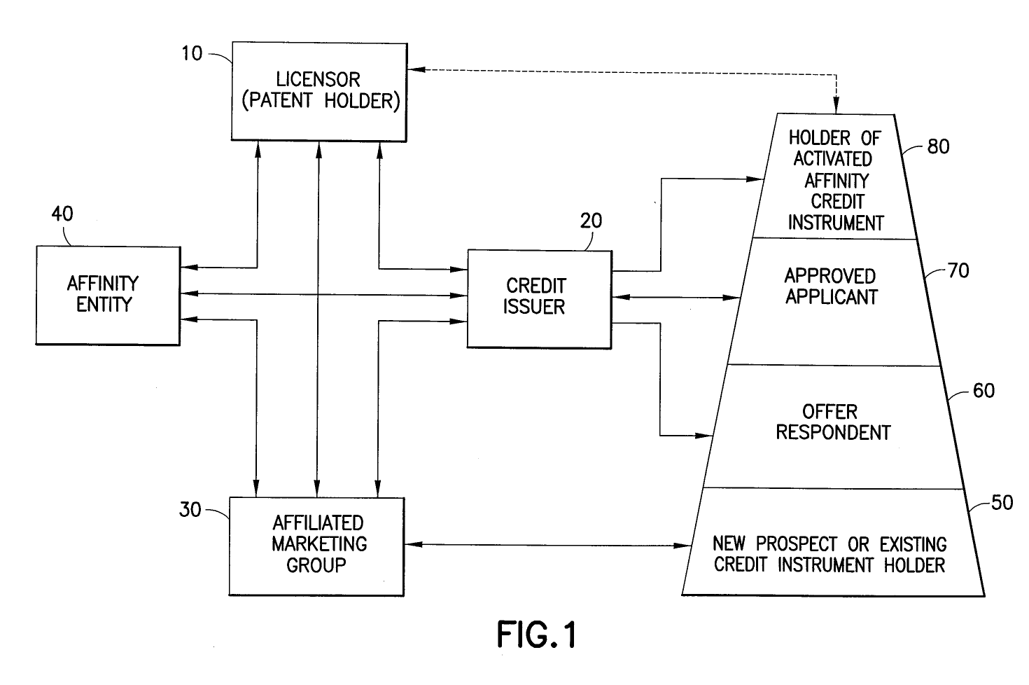

As illustrated in FIG. 1, after the owner of the present invention 10 licenses, sells, or assigns the rights in the invention to at least one credit issuer 20, the credit issuer 20 makes efforts to contract with one or more affinity entity 40, e.g., various organizations (if desired) seeking donations such as the Red Cross, universities, animal rights groups, cancer research foundations, etc., and (if desired) organizations seeking contributions such as lobbying groups, and (if desired) with affiliated merchants seeking pre- or other payments (such as cruise lines) or seeking to promote the donations or contributions, and/or with the affinity credit instrument holder by appealing to his/her self-interest affinity, for each credit instrument offering. The credit issuers 20 may add the features of the present invention, i.e., generation of excess funds to enable the donation, contribution, payment and credit features of the invention, to any existing credit instrument, such as any credit card. Alternatively, a new standalone affinity credit instrument having the ability to generate excess funds to enable the donation, contribution, payment and credit features of the present invention may be issued by the credit issuers 20 in affiliation with the affinity entities 40.

An affiliated marketing group 30, internal or eternal to the credit issuers 20 and to the affinity entity 40, may market an offer of the affinity credit instrument of the present invention to new prospects 50. Additionally, the affiliated merchant/marketing group 30 may attempt to convert the existing holders of the credit issuers' 20 existing credit instruments to become holders 80 of the affinity credit instrument.

Each respondent to the offer 60 accepts standards terms and default settings that include how to accumulate excess funds, e.g., round up change to the next highest dollar or $5 level, add a fixed amount such as a quarter or one or more dollars, add 10% of the purchase price, etc., for every transaction made, or to the total amount owed on the credit instrument, up to a maximum amount of allowable excess funds per month and for certain affinity credit instruments affiliated with its holder's self-interest, which month to convert points to an affinity credit instrument account credit.

The credit issuer 20 reviews each offer respondent's 60 credit application in accordance with standard credit practices and, upon approval, issues/provides an inactivated affinity credit instrument or feature to the approved applicant 70. Once the affinity credit instrument or feature is activated, the holder 80 is ready to enter into POS transactions which will start generating excess funds.

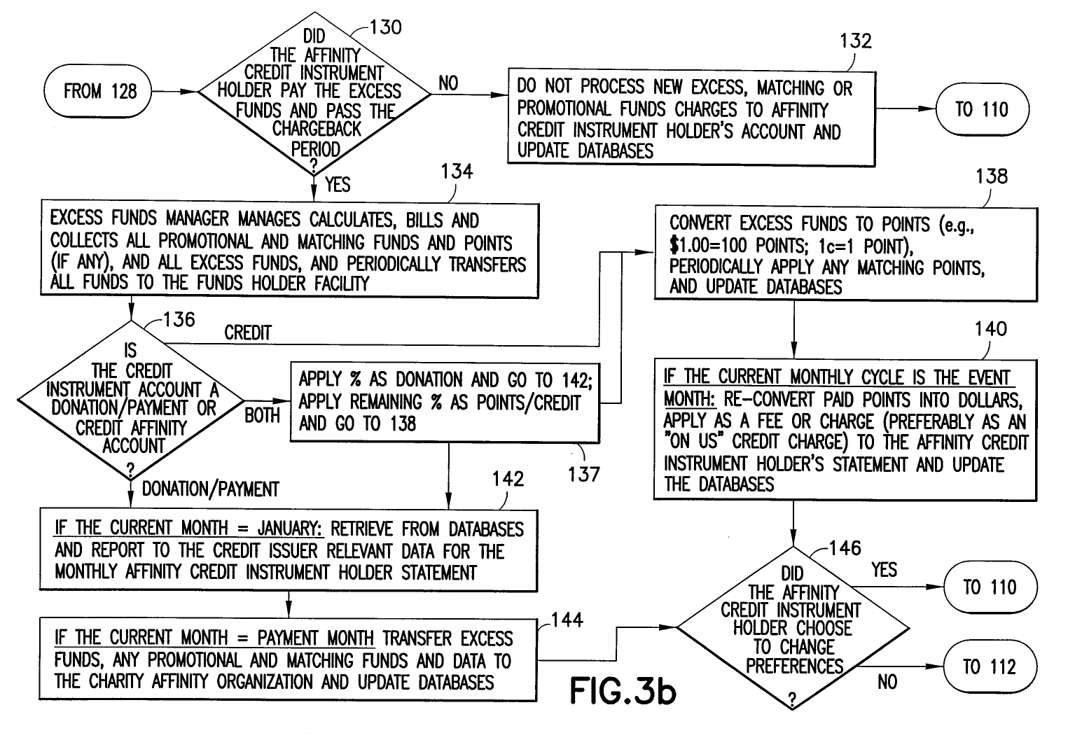

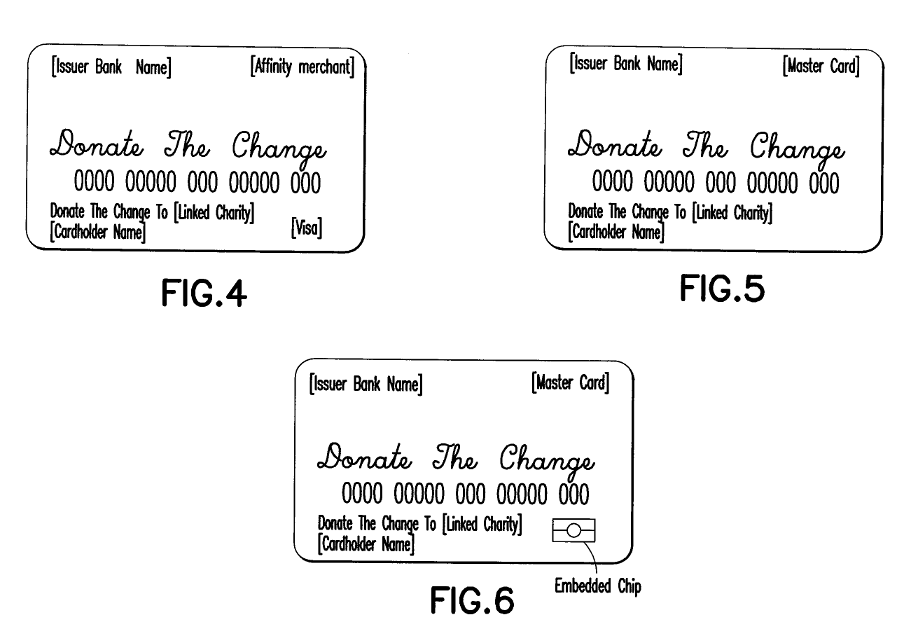

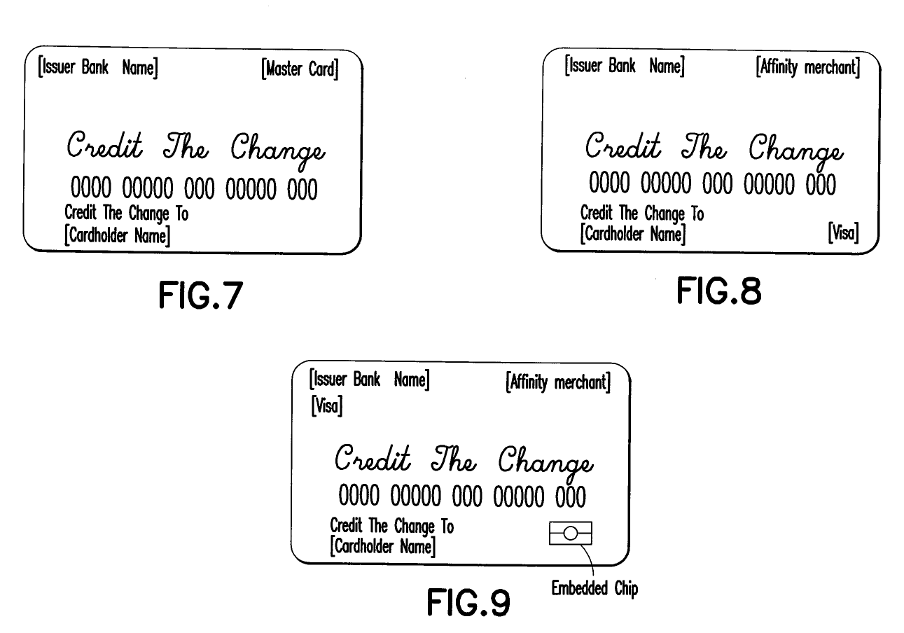

The terms of use and default settings for the issued affinity credit instrument may be accepted and the affinity instrument activated by any known manner, for example, through use of telephones, Internet connected computing devices, cell phones, personal digital assistants, and other communication devices. Examples of the credit instrument devices provided to new holders 80 are illustrated in FIGS. 4-11. In particular, FIGS. 4, 5, 6, 10 and 11 show examples of devices used to provide the excess funds as donations, contributions and payments, and FIGS. 7, 8, 9, 10 and 11 show examples of devices that generate the excess funds as credits to the affinity credit instrument.

FIGS. 4, 5, and 6 illustrate plastic wallet cards displaying the names and/or logos of the credit issuer 20, the affinity entity(ies)/organizations that will receive the excess funds, the financial processing network, e.g., for example, VISA®, MasterCard®, American Express®, Discover®, etc., and an affiliated merchant or entity, if any (see FIG. 4). Each affinity instrument could also includes its holder's name, an expiration date, applicable security codes, encoded magnetic strip, holographic id and other data and devices that are not shown in the Figures. The affinity instrument may further include an embedded chip (see FIG. 6) to interact with the applicable financial processing network.

FIGS. 7, 8, and 9 illustrate plastic wallet cards displaying the credit issuer, financial processing network, name of the holder utilizing the excess funds, and an affiliated merchant or entity, if any (see FIG. 7). Each card could also include an expiration date, applicable security codes, encoded magnetic strip, holographic id and other data or devices that are not shown in the Figures. The card may further include an embedded chip (see FIG. 9) to interact with the applicable financial processing.

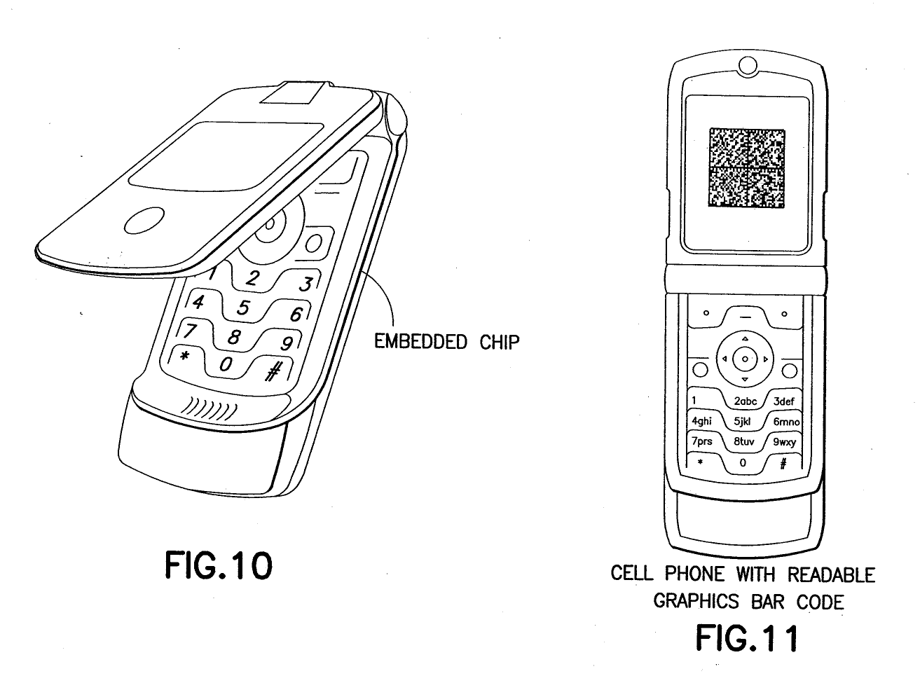

FIGS. 10 and 11 illustrate a cell or digital phone with an embedded chip (FIG. 10) and with a readable graphics bar code device and software (FIG. 11) that may be used instead of a physical credit instrument, such as a traditional credit card, to make purchases. Such devices may also require applicable security and other codes, which are not shown. The same or similar chip may be embedded in other physical devices, such as RFID road toll payment devices and the same or similar readable graphics bar code device and software may be embedded in physical devices, such as digital cameras with RFID chips, rendering such devices equivalent to a credit card.

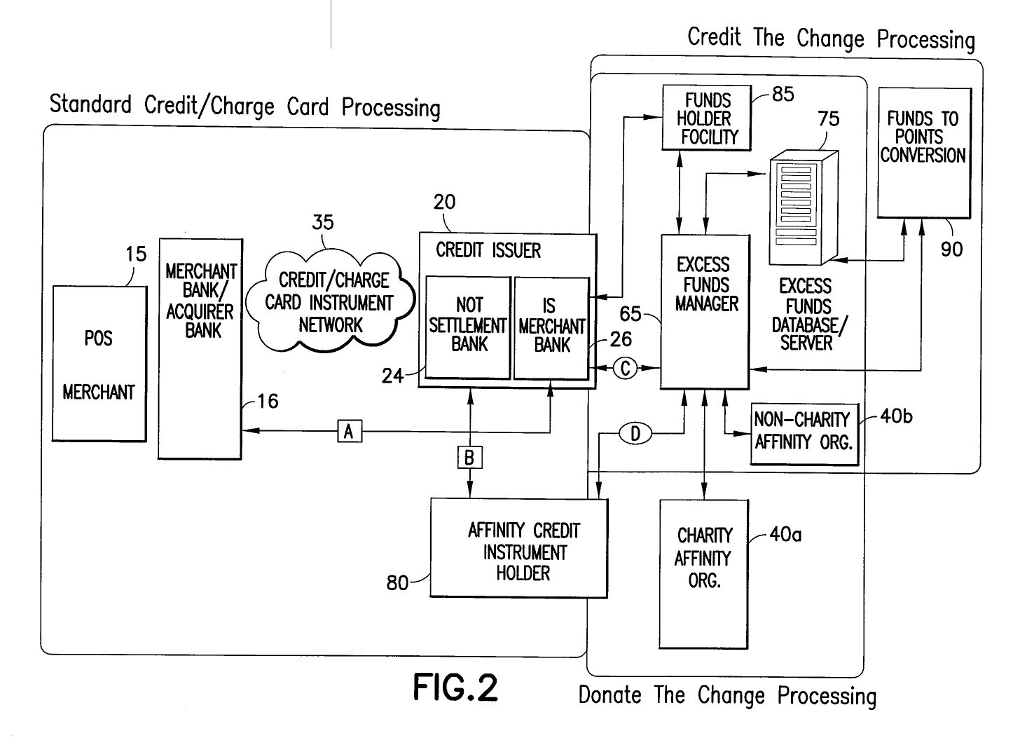

Thus, as illustrated in FIG. 2 when the holder 80 using the affinity credit instrument makes a POS purchase from a merchant 15, a transaction is generated. The merchant's bank 16 performs a settlement, i.e., the merchant's bank 16 credits or reimburses the merchant 15 for the amount of the transaction less some agreed fee and submits the transaction to the credit issuer 20 for payment via any credit instrument, e.g., credit card, processing network 35, e.g., VISA®, MasterCard®, DiscoverCard®, American Express®, SpeedPass®, in-house private dedicated networks or systems. If the credit issuer 20 is not the merchant's settlement bank 24, it pays the merchant's bank 16 the submitted amount less an interchange fee, which partially reimburses credit issuer 20 for its expenses, through the processing network 35. If the credit issuer 20 is the merchant's settlement bank 26, then processing, clearing, and settlement of the merchant payment is entirely internal to the credit issuer 20 and the processing network 35 is not used, as illustrated by arrow A. After the transaction is processed, the merchant 15 receives a payment and the credit instrument holder 80 receives a bill and pays for the purchase.

Additional information on how common credit card processing works is provided on the Internet at www.mastercard.com/us/merchant/how_works/index.html. This may also be seen in FIG. 1 of U.S. Patent Application Publication Number 20060047589.

In the normal course of business and in accordance with standard credit card transaction processing, the credit issuer 20, either directly or through a third party processor, processes all of holder's credit card transactions, and prepares and sends a monthly statement to each affinity credit instrument holder 80, to which the holder 80 responds, as illustrated by arrow B.

During periodic back-end processing of the affinity credit instrument and holder's transactions unrelated to POS transaction processing, when the credit issuer 20 recognizes the credit instrument used by the holder 80 as the affinity credit instrument, the credit issuer 20, acting as the settlement bank 24 for an excess funds manager, extracts relevant holder 80 transaction data and provides it to an excess funds manager 65, which performs the steps that generate and manage the excess funds. The excess funds manager 65 may use a database server 75 to process the extracted data to calculate the amount of the excess funds and update relevant data fields, submitting to the credit issuer 20 a fee or merchant charge, and in the preferred embodiment placing an “On Us” transaction, for the amount of the excess funds to the holder's 80 monthly statement.

The excess funds paid to the credit issuer 20 are held at the credit issuer 20 or at a funds holder facility 85 until applicable chargeback rights have expired, after which they may either be made as a donation to a charity affinity organization 40a or a contribution or payment to a non-charity affinity organization 40b (such as the holder's bank or other financial institution for deposit in one of holder's accounts), or converted to points 90, with or without matching or promotional funds or points awarded by the credit issuers or affinity organizations. If converted to points, the points are later converted back to currency and applied as a fee credit or merchant credit, and in the preferred embodiment placed as an “On Us” credit, on the holder's 80 statement during the applicable month. Each of the above activities results in applicable updates to the excess funds database server 75.

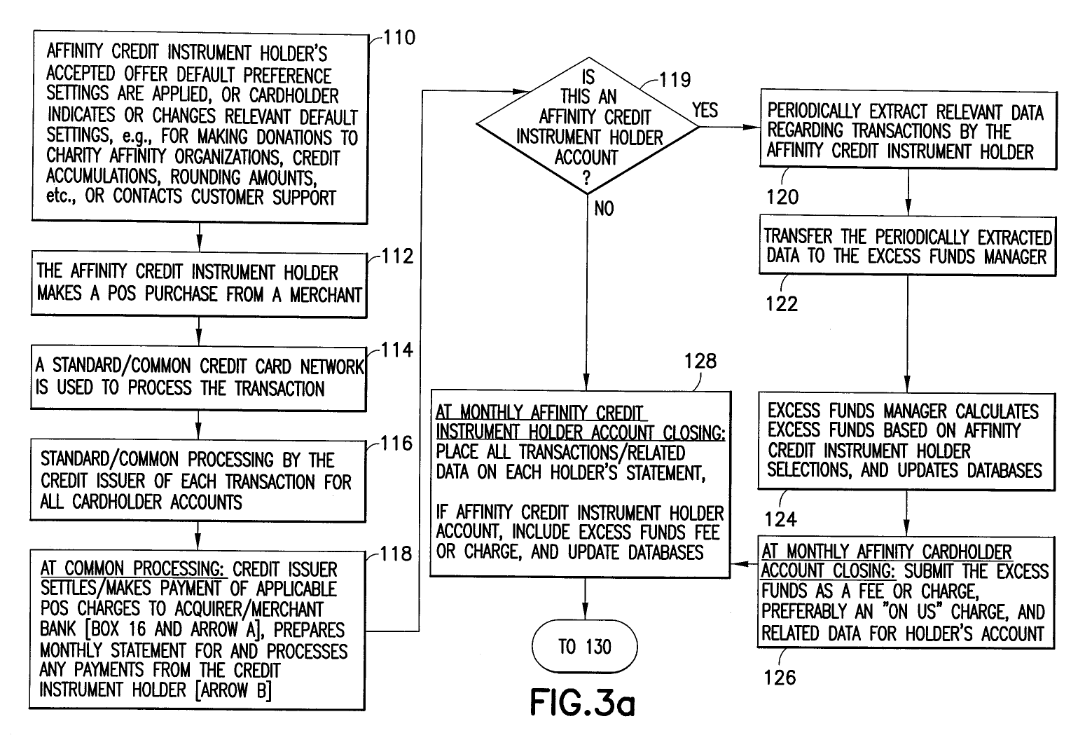

FIG. 3a illustrates the steps of the transactions illustrated in FIG. 2. First, as discussed with reference to FIG. 1, at the time the holder 80 has accepted a specific affinity credit instrument offer from credit issuers related to one or more affinity entities or to the holder's self-interest, the holder 80 accepts default settings for various preferences such as rounding amounts, maximum monthly amounts, use of excess funds generated, etc., in step 110. These preferences may be modified by the holder 80 throughout the term of holder's affinity credit instrument in accordance with the credit issuer's 20 policies. The changes may include, for example, increasing the round-up level to the next highest amount ending in $5.00 instead of $1.00 or raising or lowering the maximum monthly excess funds within predetermined limits, e.g., capped at $20 per month or any selected dollar limit.

The affinity credit instrument is a commonly used credit instrument, such as a credit card and a charge account, and any existing credit instruments may be converted and used as an affinity credit instrument, however, the credit issuer 20 must be able to determine, e.g., using the account number, that the credit instrument is an affinity credit instrument. A manner in which the holder 80 can add the features of the present invention that allow for accumulation of excess funds and donation, contribution, payment or credit of these funds is shown by arrow D (FIG. 1). For example, the holder 80 may visit a website managed by the excess funds manager or may call customer support to accept an offer with suggestions, or defaults, regarding how the excess funds are to be collected and distributed, i.e., credit or donation/contribution/payment, provide relevant account information and consent, and specify a starting period, e.g., the next regularly scheduled cycle. After the holder's information and consent are provided to the credit issuer, which may include the credit issuer's third party processor companies, the holder's account is identified or tagged as an affinity credit instrument.

At the holder's request the credit issuer may provide a new physical device, e.g., plastic credit cards shown in FIGS. 4-9. One reason for issuing the affinity credit instrument physical device is to remind their holders why they should select the particular affinity credit instrument for making POS purchases. However, it is important to note that the affinity credit instrument is a credit or charge account and no physical device is necessary to practice the present invention by making a point of sale transaction.

At step 112 a POS purchase is made by the holder 80 using the affinity credit instrument from a merchant 15 and at steps 114 the purchase transaction is processed using credit transaction network processing. The purchase using the affinity credit instrument can be made through any available, commonly used credit card means, e.g., in person at a store, via a telephone, via a fax, via cable or satellite TV, via the Internet, via a cell phone, or via PDA/wireless devices or any other credit instrument processing method without requiring additional equipment. The transaction is first processed at the merchant's bank 16 and then forwarded via the credit instrument-processing network 35 or directly (see arrow A, FIG. 2) to the credit issuer 20.

At step 116, where the credit issuer 20 is not the merchant or settlement bank, the credit issuer 24 performs standard/common processing of each POS transaction and pays the amounts owed to the merchant 15 to the merchant's bank 16, after which, the credit issuer continues to process transactions of the affinity credit instrument holders and of holders of its other credit instruments, prepares monthly statements for and processes any payments by the affinity credit instrument holders, as indicated arrow B (FIG. 2).

At step 118, as part of common processing, where the credit issuer is also the merchant's settlement bank 26, the credit issuer settles/makes payment of applicable POS charges to the merchant's account at the credit issuer 26 as indicated by arrow A (FIG. 2), prepares monthly statement for and processes any payments by the affinity credit instrument holders, as indicated arrow B (FIG. 2).

Periodically and unrelated to the POS transaction, at step 119 the use of an affinity credit instrument is determined, for example through the use of a plug-in software tool. If the affinity credit instrument was not used, common processing resumes at step 128 with, for example, preparation of an invoice for the holder 80 (FIG. 2). If the affinity credit instrument was used, then at step 120 the credit issuer 20 (or its third party processor) will periodically extract relevant transaction data and at step 122 transfer these data to the excess funds manager 65, which at step 124 calculates the correct excess funds for each and all transactions in accordance with the affinity credit instrument holder's applicable preferences and updates the database 75 with the total calculated amounts of the excess funds.

At step 126, the close of each monthly billing cycle, the excess funds manager, which, in the preferred embodiment, has been designated a fee services provider or has been issued a Merchant ID by the credit issuer 20 acting as its settlement bank 26, prepares and submits a fee or an “On Us” transaction as a charge to the affinity credit instrument holder's account for the amount of the monthly calculated total excess funds and other relevant information for inclusion in the text portion of the holder's monthly statement via the notes or comments field of the relevant transaction.

At step 128, the credit issuer 20 prepares the monthly statement for affinity and non-affinity credit instrument holder's accounts. The “On Us” or other charge or fee for the applicable excess funds is included for each affinity credit instrument holder as well as related explanations. Relevant databases are updated with the statement information and credit issuer 20 issues the statements to each affinity credit instrument holder.

From time to time, the credit issuer 20 also makes payment to the merchant's bank 16 for each applicable merchant POS transaction via standard procedures, less applicable fees.

As illustrated in FIG. 3B, in step 130, it is determined if, after a predetermined time interval following issuance of the monthly statement during which the affinity credit instrument holder may legally question or refuse to pay the excess funds (“chargeback period”), the holder 80 fails, questions or refuses to pay the excess funds amount due, at step 132 the credit issuer 20 will take whatever action is warranted in accordance with standard policies and procedures, for example, reporting the account to customer service 110 and failing to process new excess fund into the holder's credit instrument account.

Alternatively, if the excess funds payment is made by the affinity credit instrument holder and the chargeback period has ended, the excess, matching and promotional funds are, at step 134, collected and deposited into the excess funds manager's account at the credit issuer, are periodically transferred to the funds holder facility 85 (FIG. 2) and the databases will be updated.

If it is determined at step 136 that the holder has selected to use some or all of the excess funds to provide a donation/contribution/payment, then at step 142, for the January monthly statement the prior year's total amount of excess funds paid to the affinity entity is included and, at step 144, during the months designated for payment of pending excess funds to the affinity entity, e.g., quarterly, semiannually, etc., all pending excess funds and related matching or promotional funds will be transferred to the affinity entity(ies) earmarked by the holder's affinity credit instrument and the databases will be respectively updated.

The databases are updated with relevant information, e.g., add the amount transferred to the affinity entity to the “paid excess funds” total year to date, decrease the “pending excess funds” by an equal amount. Additionally, any matching or promotional amounts may be added in accordance with stated promotions, which are separately calculated, billed, and collected via data transfers/requests to the affinity entity(ies) based on affinity credit instrument holder's activity/transactions.

Further, the affinity entities may be provided with reports 144, including information regarding each holder's total donations/contributions/payments. Such information may enable the affinity entities to issue receipts or statements required by law or regulation and to efficiently combine the information of donations/contributions/payments made through the affinity credit instrument with information regarding other donations/contributions/payments made by the same affinity credit instrument holder independent of the affinity credit instrument of the present invention. Such information may also be useful to the affinity entities for donor, contributor or payment database management and for preparing combined donation, contribution and payment receipts and statements of total individual donations/contributions/payments made in given year or as of a certain date, e.g., university alumni/ae donations made through the affinity credit instrument would be added to other contributions by the same alumni/ae for total tax-deductible donations receipt and recognition in an annual giving campaign period.

Where at step 136 it is determined that the credit instrument holder selected to use some or all of the excess funds under the credit feature of the present invention, at step 138 such excess funds will be converted to points, for example, $0.01=1 point, $1.00=100 points, etc, and the points are recorded in the databases. At step 140, when the affinity credit instrument holder's monthly invoice cycle is the default month, e.g., December Holiday Shopping credit, or is the month selected by the affinity credit instrument holder for an event; e.g., August Vacation credit, September College Books credit, etc., points are reconverted to dollars at the same ratio, i.e., 100 points=$1.00, and the resulting credit is applied to the holder's statement while appropriate updates are made to the database. In this fashion, the affinity credit instrument holder receives the benefit of “spending” their excess funds in a planned, pre-determined month against anticipated expenses through additional use of the affinity credit instrument.

Any promotional matching funds, matching points or other promotions offered by the credit issuer 20, any affiliated merchant, the excess funds manager or other third parties, e.g., a major charity donor, will also be calculated, invoiced, collected and deposited by the excess funds manager 65 in the in the excess funds manager's account at the credit issuer 20 or in the funds holder facility 85 (FIG. 2), and the database 75 will be updated with all the relevant information, and the matching or promotional funds paid to the affinity entity, however donations will NOT be paid in the affinity credit instrument holder's name for tax receipt purposes, or converted to points and deposited in the holder's account for standard points treatment.

Any customer support issues are handled by standard customer support systems managed by the credit issuer and the excess funds manager as described in step 110. Additionally, affinity credit instrument holders may be given access to specific customer support systems and data interfaces at secure web-sites, including for changing their preferences related to the use of the affinity credit instrument as described in Step 110.

Finally, the processing of steps 140, 142 and 144 are completed and at step 146, it is determined if the affinity credit instrument holder has made any changes to its profile, i.e., as in step 110; if so, those changes are applied at step 110. Otherwise processing resumes at step 112 where POS purchases are made by the affinity credit instrument holder.

The present invention has been described herein by the preferred embodiments, it will be understood that those skilled in the art that various changes may be made and added to the invention. The changes and alternatives are considered to be within the spirit and scope of the present invention.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A method of generating excess funds through use of a credit instrument, the excess funds being earmarked for at least one entity, the method comprising the steps of:
at least one credit issuer affiliating a credit instrument with the at least one entity;
at least one consumer obtaining the affiliated credit instrument and using it to make one or more purchase transactions at one or more points of sale, each transaction having an amount of purchase; and
the at least one credit issuer processing each of the one or more purchase transactions by performing credit instrument transaction processing procedures using a credit instrument processing network;
providing a computer that communicates with the network;
providing software executing on the computer that determines if the instrument is the affiliated credit instrument;
at first intervals predefined for calculating excess funds, determining with the software if an instrument used to pay for the purchase transaction being processed is the affiliated credit instrument and, if so, calculating the amount of the excess funds for each first interval, and maintaining a running total of such excess funds , the excess funds being calculated for each purchase transaction using the affiliated credit instrument by adding an amount to the purchase transaction, said excess funds not being charged to the consumer at each first interval;
at second intervals predefined for generating the excess funds, each of said second intervals being separate and apart from the one or more point of sale transactions, generating with the software excess funds in the amount of the running total of such excess funds for the second interval which excess funds are then charged to the consumer.

2. The method of claim 1, wherein the credit instrument is selected from at least one of a pre-existing credit instrument and a newly issued credit instrument.

3. The method of claim 2, wherein the credit instrument is selected from at least one of a physical manifestation including a card and a non-physical manifestation including a credit line and a charge account.

4. The method of claim 1, wherein the at least one entity is selected from at least one of not-for-profit organizations, charitable organizations, educational and research organizations, lobbying and political organizations, health-care providers, for-profit entities and the at least one consumer.

5. The method of claim 4, further comprising a step of marketing the affiliated credit instrument to the at least one consumer having an affinity to the at least one entity.

6. The method of claim 1, wherein the excess funds are generated for the use selected from at least one of a donation, contribution, payment, and credit accumulation.

7. The method of claim 1, wherein the step of generating the excess funds is performed by a program of instructions of the software that calculates a value that is added to the sum-total amount of all purchase transactions, the value comprising the sum of the amounts added but not charged to each of the purchase transactions, the program of instructions comprising the following steps:
utilizing parameter settings indicated by the at least one consumer,
determining a difference between the amount of each purchase and a predefined quantity selected by the at least one consumer, and adding the difference to the running total.

8. The method of claim 7, wherein the predefined quantity is changeable by the at least one consumer and is selected from at least one of rounding up each transaction amount to the next highest dollar or an integral number of dollars, adding a predetermined fixed number to each transaction amount, adding a predetermined percentage to each transaction amount, adding a predetermined fixed number to the a sum total amount, and adding a predetermined percentage to the a sum total amount.

9. The method of claim 7, wherein the predefined quantity further includes a limit amount changeable by the at least one consumer, the limit amount setting a maximum periodic limit on the amount of the excess funds.

10. The method of claim 7, wherein the step of generating the excess funds further includes the step of calculating, collecting, and applying promotional funds, matching funds and points provided by at least one of the credit issuer and the at least one entity.

11. The method of claim 10, wherein the consumer earmarks a portion of the generated funds to be distributed to a particular one of the at least one entity.

12. The method of claim 11, further comprising a step of transferring the generated funds including the promotional funds and the matching funds, to the at least one entity for which the excess funds are earmarked.

13. The method of claim 10, further comprising a step of converting the excess funds as well as the promotional funds and the matching funds to points, the points being applied as at least one credit to the instrument.

14. The method of claim 1, further comprising a step of billing a fee, merchant or “On Us” transaction charge to the at least one consumer in the amount of the excess funds at the close of each billing cycle for that at least one consumer.

15. The method of claim 14, further comprising a step of providing information of year to date and of a prior year's total amount of excess funds generated for the instrument including all collected matching and promotional funds paid in the name of the at least one consumer to the at least one entity at the close of each second interval and yearly cycles.

16. The method of claim 1, wherein the credit instrument-processing network is selected from VISA®, MasterCard®, DiscoverCard®, American Express®, SpeedPass®, private vendor network, and other credit instrument-processing processing networks.

17. A method of generating excess funds through a use of a credit instrument affiliated with at least one entity and issued to at least one consumer by a credit issuer, wherein the at least one consumer makes at least one purchase transaction at one or more points of sale using the credit instrument, the method comprising the steps of:
processing each purchase transaction via a processing network including a computer that communicates with the network;
operating software on the computer capable of recognizing the credit instrument used in the purchase transaction being processed as being affiliated with the at least one entity;
determining with the software if the credit instrument is affiliated with the at least one entity;
the software operating at first periodic intervals and calculating funds for each purchase transaction in excess of a value of each purchase transaction and a running total of said excess funds if the software recognizes the credit instrument as being affiliated with the at least one entity, the excess funds not being charged to the consumer at each first periodic interval;
the software further operating at second periodic intervals wherein the second periodic intervals comprise a plurality of said first periodic intervals, said second periodic intervals being separate and apart from said point of sale purchase transactions, the software generating a sum total of said excess funds for said second periodic interval;
billing an amount of the excess funds generated using the credit instrument to the at least one consumer prior to the close of a billing cycle; and
distributing the excess funds at the close of a reporting cycle in the name of the at least one consumer to a particular one of the at least one entity with which the credit instrument is affiliated.

18. The method of claim 17, wherein the excess funds are distributed in a form selected from at least one of a donation, a contribution, a payment, and at least one credit against future purchases.

19. The method of claim 18, wherein the excess funds are distributed to more than one affinity entity as a donation, contribution, payment or credit against future purchases.

20. The method of claim 19, wherein the step of calculating excess funds comprises the steps of:
utilizing parameter settings indicated by the at least one consumer;
determining a difference between the amount of each purchase and a predefined quantity selected by the at least one consumer ;
adding the difference to a the running excess funds total; and the step of generating the excess funds further comprising
calculating, collecting, and adding promotional and matching funds provided by the credit issuer and the at least one entity to the running excess funds total.

21. A method of generating excess funds through a credit instrument issued to at least one consumer by at least one credit issuer, the credit instrument being usable for making one or more purchase transactions at one or more points of sale using a credit instrument processing network, the method comprising the steps of:
operating a computer that communicates with the credit instrument processing network;
at predefined first periodic intervals performing credit instrument processing procedures using a the credit instrument processing network;
determining, using software executing on the computer, if an instrument being processed is designated as an affiliated credit instrument such that the instrument is affiliated with a third party entity and if so, calculating excess funds for each purchase transaction for such first periodic interval, such that an amount indicated by the consumer is added to the value of the purchase transaction;
adding the excess funds to a running excess funds total;
said excess funds not being charged to the consumer at said first periodic intervals;
at second periodic intervals that are less frequent than said first periodic intervals, and that are separate and apart from said point of sale purchase transactions, generating the excess funds as said running excess funds total; and
billing the consumer for a sum total amount owed by the consumer on the credit instrument and including the amount of the running excess funds total for the second periodic interval.

22. The method of claim 21, wherein further comprising the steps of:
earmarking the excess funds for distribution to one or more entities selected from at least one of not-for-profit organizations, charitable organizations, educational and research organizations, lobbying and political organizations, health-care providers, for-profit entities and a plurality of self-interests of the at least one consumer; and
distributing the excess funds in the name of the consumer to a particular entity of the one or more entities at the close of a predefined periodic cycle.

23. The method of claim 22, wherein the consumer earmarks a portion of the excess funds to be distributed to the particular entity.

24. A system for generating excess funds through a credit instrument issued to at least one consumer by at least one credit issuer, the credit instrument being usable for making one or more purchase transactions at one or more points of sale using a credit instrument processing network, the system comprising:
a computer that communicates with the credit instrument processing network;
at predefined first periodic intervals, the credit instrument processing network operating to perform credit instrument processing procedures;
the computer executing software to determine if an instrument being processed is designated as an affiliated credit instrument whereby the instrument is affiliated with a third party entity and if so, to calculate excess funds for each purchase transaction for such first periodic interval, such that an amount is added but not charged to the value of the purchase transaction and the excess funds are added to a running excess funds total;
said excess funds not being charged to the consumer at said first periodic intervals;
at second periodic intervals that are less frequent than said first periodic intervals, and that are separate and apart from said point of sale purchase transactions, said computer generating the excess funds as said running excess funds total and billing the consumer for a sum total amount owed by the consumer on the credit instrument and including the amount of the running excess funds total for the second periodic interval.
